(19) United States
(12) Patent Application Publication
(10) Pub. No.: US 2026/0081506 A1
(43) Pub. Date: Mar. 19, 2026

(54) METHOD AND SYSTEM FOR PRODUCING A STATOR FOR AN ELECTRIC MACHINE

(71) Applicant: Ford Global Technologies, LLC, Dearborn, MI (US)

(72) Inventors: Raphael Koch, Odenthal (DE); Jochen Schenk, Bonn (DE); Goekhan Tasgin, Cologne (DE)

(73) Assignee: Ford Global Technologies, LLC, Dearborn, MI (US)

(21) Appl. No.: 19/334,391

(22) Filed: Sep. 19, 2025

(30) Foreign Application Priority Data
Sep. 19, 2024 (DE) 10 2024 127 077.2

(51) Int. Cl. H02K 15/0273; H02K 1/02; H02K 15/027; H02K 15/121; H05B 6/10

(52) U.S. Cl. CPC H02K 15/0273; H02K 1/02; H02K 15/027; H02K 15/121; H05B 6/101

(57) ABSTRACT

The disclosure relates in general to a method and a system for producing a stator for an electric machine. The stator has a laminated core with individual adjacently arranged steel sheets along an axial direction of the stator. At least some portion of the steel sheets has an electric insulating material. The steel sheets of a laminated core of a stator are stamped out of a raw material. The steel sheets are stacked along the axial direction of the stator to form the laminated core. The steel sheets of the laminated core are clamped along the axial direction of the stator. The clamped laminated core is accommodated in a receptacle. Cut edges of the clamped laminated core accommodated in the receptacle are heated by a heating device in such a way that eddy currents are induced in at least one external portion of the laminated core.

### CROSS-REFERENCE TO RELATED APPLICATION

This application claims priority to and the benefit of German Patent Application No. 10 2024 127 077.2, filed on Sep. 19, 2024. The disclosure of the above application is incorporated herein by reference.

### FIELD

The disclosure relates in general to a method and a system for producing a stator for an electric machine.

### BACKGROUND

Electric motors have rotors and stators. Nowadays, these are often formed by laminated cores, which have individual steel sheets that are bonded, stamped or welded together. In this context, the steel sheets are of course electrically insulated by means of a coating. The steel sheets are typically stamped out of a raw material. The stamping process gives rise to cut edges. However, these cut edges form local structural ridges, making it more difficult to form magnetic domains in the individual steel sheets. Dislocation lines may be caused in the grain structure of the magnetic domains, for example, thereby negatively affecting the electromagnetic properties of the laminated cores. When viewed from an external surface of the laminated core, such structural ridges may extend into the laminated core to depths in the millimeter range.

In this context, U.S. Pat. No. 10,879,777 B2 discloses that the corresponding laminated cores can be heated. For this purpose, the laminated cores are inserted into a continuous annealing furnace in order to heat them for a defined time, e.g. 10 minutes, to a healing temperature of about 700° C. Since the boundary surfaces and boundary structures of the laminated core exhibit higher heat absorption, the edge regions of the laminated core, in particular, may be locally heated. This has the effect that the structural degradations can be at least reduced or even healed.

However, this makes the heating process time consuming and requires more resources due to the operation of the continuous annealing furnace. In addition, the relatively long duration of the heating has the effect of causing degradations in respect of the electric insulating coatings and/or adhesive coatings of the steel sheets. As a result, the electric insulation between the steel sheets or the coupling with adjacent steel sheets is destroyed, which in turn has a negative effect on the electromagnetic properties of the laminated core as a whole.

As regards the electric motor, the stator is of greater interest since, in the case of rotors, when considered in relative terms, less material is used, for which reason the structural ridges have less of an effect. In addition, very much greater power losses are caused by the magnetic rotating field in stators than in rotors, which merely move along in the rotating field.

### SUMMARY

This section provides a general summary of the disclosure and is not a comprehensive disclosure of its full scope or all of its features.

The object is achieved by the subjects of the independent patent claims. Advantageous refinements are indicated in the dependent patent claims and the following description, and each may represent aspects of the disclosure either individually or in (sub-)combinations. Some features are explained with respect to methods, others with respect to systems. However, the corresponding aspects can be applied to either as appropriate.

According to one aspect of the present disclosure, a method for producing a stator for an electric machine is disclosed. The stator has a laminated core which has individual adjacently arranged steel sheets along an axial direction of the stator. At least some portion of the steel sheets has an electric insulating material. The method comprises at least the following steps:
The steel sheets of a laminated core of a stator are stamped out of a raw material.
The steel sheets are stacked along the axial direction of the stator to form the laminated core.
The steel sheets of the laminated core are clamped at least along the axial direction of the stator.
The clamped laminated core is arranged in a receptacle.

At least cut edges of the clamped laminated core accommodated in the receptacle are heated by a heating device in such a way that eddy currents are induced in at least one external portion of the laminated core.

The method is based on the insight that an induction heating method (referred to as flash annealing) can be used to heat the laminated core of the stator to desired temperatures for extremely short periods of time. Since the structural ridges represent boundary structures and boundary surfaces in the laminated core, they absorb a disproportionately large amount of heat energy, and it is therefore particularly these locations which undergo local heating. This can be provided, for example, through a suitable choice of frequency for the induction heating method since the frequency has an effect on the penetration depth of the heat energy induced. It is thereby possible to provide that the temperature rise is primarily locally limited, and the center of the laminated core undergoes relatively little change in temperature. As a result, it is possible to provide with greater precision than hitherto that the electric insulating coating and/or likewise the adhesive layers of the steel sheets remain intact. The adhesive layers are used to a couple adjacent steel sheets to one another. This makes it possible to maintain the insulation and connection between the individual steel sheets of the laminated core, thus enabling a lower reject rate for the stator.

In addition, the induction heating method can be used in a very energy-efficient way, in particular in a more energy-efficient way than is the case for continuous annealing furnaces. Thus, the power consumption per stator can be reduced, leading to a further increase in efficiency of production.

Nevertheless, the sudden very powerful heating, particularly of the external portions of the laminated core, is sufficient to heal the structural ridges. As a result, it is possible to reduce negative influences on the formation of the magnetic domains, thus enabling the electromagnetic properties of the stator to be configured as desired.

By virtue of the fact that the structural ridges can be healed to a greater extent and more precisely than in previous approaches, it is optionally possible to use a raw material that is easier to acquire, and reduce the resources for the production of a stator.

According to another aspect, the present disclosure provides a system for producing a stator for an electric machine. The system has at least one stamping device, which is configured to stamp steel sheets of a laminated core of a stator out of a raw material. The system has at least one stacking device, which is configured to stack the stamped steel sheets along an axial direction of the stator to form a laminated core. The system has at least one clamping device, which is configured to clamp the stacked stamped steel sheets of the laminated core at least along the axial direction of the stator. The system has a receptacle, which is configured to accommodate the clamped laminated core. The system has at least one heating device, which is configured at least to heat at least cut edges of the clamped laminated core accommodated in the receptacle in such a way that eddy currents are induced in edge regions of the laminated core.

The advantages which are achieved by the method described herein are also achieved in corresponding fashion by the system.

The laminated core can be understood as a stack of steel sheets arranged along an axial direction (also referred to as the direction of longitudinal extent) of the laminated core, which are arranged directly adjacent to one another in pairs. To form the laminated core, adjacent steel sheets are stamped (also referred to as “interlocked”), bonded or welded together.

in one form, the axial direction of the laminated core and thus of the stator also corresponds to the axis of rotation about which the rotor rotates relative to the stator.

As an option, the insulating material is, in particular, arranged with respect to the individual steel sheets in such a way that adjacent steel sheets are electrically insulated from one another. In this way, it is possible to reduce the induced eddy currents through the stacked individual steel sheets. This leads to properties which correspond more precisely to the specifications. It is thereby possible, for example, to reduce power losses caused by the eddy currents.

The raw material can be understood, in particular, to mean a raw steel from which the steel sheets are cut, stamped or, more generally, separated. The steel sheets form individual blanks, which are joined together to form the laminated core. The raw steel comprises a material which is suitable for the laminated core of the stator. The raw steel should not be interpreted to mean structural steel or the like. For example, the raw steel in one form comprises electric sheet steel, and therefore the steel sheets are in this variation are formed from electric sheet steel. Electric sheet steel has proven to be particularly suitable for the formation of laminated cores for parts of an electric machine since it has outstanding electromagnetic properties in comparison with other steel grades.

Alternatively to the stamping of the steel sheets from the raw material, the steel sheets can also be separated from the raw material by means of some other production technique, e.g. by laser cutting, electric arc cutting, water jet cutting, erosion or the like.

The steel sheets in one variation have a substantially mutually corresponding circumferential contour along the axial direction of the stator. As soon as the steel sheets for the formation of the laminated core have been stacked, a uniform circumferential contour of the laminated core is thus formed. In particular, the steel sheets are also aligned with one another in respect of their angular position, relative to a reference angular position, in the formation of the laminated core.

In some forms, a desired angular position of steel sheets of a laminated core can also be brought about and provided within the production die, e.g. a stamping die. This means that the steel sheets are already appropriately oriented within the production die and also fixed, e.g. by an adhesive bond, according to the desired orientation.

As an option, the steel sheets have markings or imprints for alignment, by means of which it is possible to ascertain which steel sheets must be arranged adjacent to one another and in what relative alignment. For example, the markings can be arranged on a circumferential surface, i.e. radially on the outside. This provides that the markings themselves are still visible when the laminated core has been formed. For example, such markings can also be used to check after assembly of the laminated cores is complete in order to make it possible to check whether the layer sequence and orientation is as desired.

Clamping the steel sheets of the laminated core makes it possible to provide a defined alignment of the individual steel sheets relative to one another during the heating process. In addition, clamping provides that thermally induced stresses resulting from the different thermal expansion coefficients of the centers of the steel sheets and the raised cut edges can be compensated. Moreover, clamping inhibits magnetic separation of the steel sheets, which may otherwise be caused by magnetically based repulsion forces of magnetic domains of different steel sheets. This is all the more important since the heating device used induces eddy currents in at least an external portion of the laminated core. The eddy currents likewise induce magnetic fields, which can cause repelling forces, which may in general result in reorientation of individual steel sheets of the laminated core. The clamping is strong enough to enable the induced magnetic fields to be overcome in order to inhibit reorientation.

The receptacle is optionally configured in such a way that the laminated core can be heated in the receptacle by the heating device. The receptacle can be part of the heating device.

In one form, the heating device is configured in such a way that the heating mechanism is based on an inductive process. This means that local currents, in this case eddy currents, are induced in the external portion of the laminated core, resulting in local heating of the corresponding structures, as in the case of an induction stove. For this purpose, the heating device is coupled to a corresponding voltage source in order to induce eddy currents in the at least one external portion of the laminated core. Since the efficiency of the induction process depends on the distance between the inductor and the body in which the corresponding eddy currents are induced, in this case the laminated core, the heating device is configured in such a way that the underlying inductor can be arranged close to the laminated core. Of course, it is possible here to make use of correspondingly electrically insulating materials, using which it is possible to provide that no direct flow of current can occur between the inductor and the laminated core.

in one form, the heating device heats the laminated core by an inductive heating method based on a high-frequency alternating current. Using a high-frequency alternating current in the inductor on which the heating device is based makes it possible to increase the efficiency of the heating process. Thus, the cut edges of the laminated core can be heated more efficiently than hitherto, with a reduced power consumption relative to earlier approaches. Moreover, excessive heating of the internal regions of the laminated core can be inhibited.

In some forms, the external portion of the laminated core is heated for a maximum heating time of 100 s (seconds). In one form, the laminated core is heated for a maximum heating time of between 0.1 and 100 s. In variations of this form, the external portion of the laminated core is heated for: a maximum heating time of 50 s, a maximum heating time of 20 s, a maximum heating time of 10 s, a maximum heating time of 5 s, a maximum heating time of 1 s ±0.7 s, or a heating time of at least 0.1 s. It is thereby possible to provide that the external portion of the laminated core is heated only for particularly short periods of time. As a result, the propagation of heat into the center of the laminated core is reduced. It is thereby possible to enable only the cut edges, to be heated, without other significant parts of the steel sheets of the laminated core being heated. Thus, electric insulating layers and/or adhesive layers, which can optionally be applied to the steel sheets, can be protected from excessive heating.

The heating device is in one form configured to heat the cut edges of the clamped laminated core accommodated in the receptacle in such a way that tensile stresses are induced in the cut edges. In other words, the local powerful heating of the cut edges in the region of the external portion of the laminated core also leads to the occurrence of tensile stresses in these regions after subsequent cooling. Such tensile stresses additionally lower the iron losses in the underlying soft magnetic material, e.g. electric sheet steel, thus ensuring that the electromagnetic properties of the laminated core as a whole correspond more precisely to the desired properties. Here, the tensile stresses compensate, in particular, for compressive stresses that are usually caused by the structural ridges. This can be demonstrated by magnetic measurements, for example. Magnetic measurements can be carried out, for example, by means of what are referred to as Epstein frames, single sheet testers or stator testers. By the single sheet tester, it is possible, for example, to detect the magnetic properties under load, that is to say under tensile or compressive stresses. This is comparable with magnetic measurement of a trouser test piece clamped in a tensile testing machine.

In one form, the external portion of the laminated core has a maximum temperature of 1500° C. In variations of this form, the maximum temperature is 1200° C., 1000° C., 800° C., or 700° C.±10%, for the heating time. In one form, the maximum temperature is between about 700° C.±10% and 1500° C. In particular, a local temperature of about 700° C. has proven particularly efficient in order, on the one hand, to heal the cut edges and, on the other hand, to inhibit the center of the laminated core or any insulating layers and/or adhesive layers from being negatively affected.

In some forms, the external portion of the laminated core is at a maximum distance of less than 10 mm from an external surface of the laminated core. In variations, the maximum distance is less than 5 mm, the maximum distance is less than 3 mm, the maximum distance is less than 1 mm, and/or the maximum distance is less than 0.5 mm±0.3 mm. This provides that only the external portion of the laminated core is heated in accordance with the abovementioned parameters. This is based on the fact that only the external portion has the structural ridges caused by the cut edges.

Of course, the external surface may also refer to a radially inner surface. In this sense, the external portion should not be understood to mean radially on the outside but as “external” in terms of a radially inner or outer external surface of the laminated core. For example, the stator slots also have an external surface with which the external portion stands in relationship.

For heating in the context of the heating device, use is optionally made of at least one inductor which has an inductor contour corresponding in design, at least in some portion or portions, to a contour of the laminated core. As a result, the inductor contour of the inductor is matched to the contour of the laminated core, thus making it possible to provide a constant spacing between the inductor and the laminated core, e.g. over a wide area of the external surface of the laminated core. Thus, more uniform heating of the external portion of the laminated core over a wide area of the external surface of the laminated core is made possible. Consequently, this inhibits individual portions of the external surface of the laminated core from being subjected to particular, diverging heating parameters.

The inductor of the heating device is in one form configured in such a way that it can be produced by an additive method or of a soldering method. In particular, the inductor can have at least one body portion which can be produced by an additive method and/or of a soldering method. For example, the inductor can be produced from semifinished products, in particular copper sheets and/or copper tubes, which are soldered. This enables the inductor to be produced and matched to various geometries of the laminated core in a particularly efficient way. In addition, the inductor can be reusable, thereby enhancing environmental compatibility.

As an option, the inductor has an internal enclosed cooling channel, through which a coolant can flow. The heating process causes a buildup of heat in the inductor. In this case, the heat in the inductor is primarily caused by the I²R losses in the copper due to the high amperage. To this is added a buildup of heat in the inductor on the basis of heat radiation by the laminated core. The temperature of the inductor can be held constant by the coolant. By keeping the parameters of the inductor constant, it is thus also possible, for example, to provide constant heating parameters of the underlying heating process, as a result of which the external portion of the laminated core is heated more uniformly.

In some forms, the heating device is configured to heat the cut edges of the laminated core by an alternating current, wherein the alternating current has a minimum frequency of at least 1 kHz, at least 50 kHz, at least 100 kHz, or at least 200 kHz, in various forms.

In various forms, the alternating current has a maximum frequency of less than 20 MHz, less than 10 MHz, less than 5 MHz, or less than 2 MHz.

At such high frequencies for induction heating (several 100 kHz and into the Mhz range), the temperature is primarily increased at the boundary surfaces and boundary points of the laminated core. This is due to the breaking of symmetry since, on the basis of Ohm's law, the induced eddy currents are thereby converted into thermal energy, i.e. heat, especially in the regions of structural changes. For example, frequencies of the alternating current of about 1 Mhz for periods of time less than or equal to 1 s, provide a very low heat input to the center of the laminated core. In effect, the heat input can be limited to an external portion which is at a maximum distance of 0.5 mm or less from the external surface (as explained above, the external surface is not necessarily to be understood as radially on the outside, and it may also be on the inside diameter of the laminated core or in the stator slots).

As an option, the inductor of the heating device is designed as a coil. As a result, it is possible to induce eddy currents in the laminated core in a particularly efficient way since the coil determines a defined orientation of the magnetic field generated by the energized coil.

The body portion of the inductor in one form has an inductor contour that corresponds in design to a slot contour of a slotted portion of the stator. The stator typically has a plurality of slots, thus enabling stator teeth to be formed. The inductor contour can therefore be designed to correspond to the slot contour of the slotted portion of the stator. Thus, the inductor contour is such that a constant spacing can be provided over a wide area of the external surface of the stator, in particular of the laminated core thereof. In particular, the constant spacing can be provided in the region of the stator slots of the laminated core. Consequently, uniform heating parameters of the heating process are provided.

In some forms, the heating device has at least one additional inductor. The additional inductor has an additional inductor contour in some portion or portions, which is designed to correspond to a cavity contour of an internal free space of the stator. Using a plurality of inductors makes it possible for the geometries thereof to be simpler. Nevertheless, it is made possible in this way to enable an induction heating process in respect of an additional component portion of the laminated core. In particular, the heating processes by the inductor and of the additional inductor can be carried out at least partially with a time overlap, thereby making it possible to reduce the production time for the production of the stator. Moreover, it is possible in this way to heal additional cut edges of the laminated core by heating, such that the electromagnetic properties of the laminated core and thus of the stator can be matched more closely to the specifications.

All the features explained in respect of the various aspects can be combined individually or in (sub)combination with other aspects.

Further areas of applicability will become apparent from the description provided herein. It should be understood that the description and specific examples are intended for purposes of illustration only and are not intended to limit the scope of the present disclosure.

### DRAWINGS

The disclosure is described and explained in greater detail below by means of the examples illustrated in the drawings. In the drawings:

FIG. 1 shows a simplified schematic illustration of a system for producing a stator for an electric machine according to the present disclosure;

FIG. 2 shows a simplified schematic illustration of a stamped steel sheet of a stator according to the present disclosure;

FIG. 3 shows a simplified schematic illustration of a laminated core of a stator according to the present disclosure;

FIG. 4 shows a simplified schematic illustration of inductors of the heating device according to the present disclosure;

FIGS. 5A and 5B show simplified schematic illustrations of a portion of the laminated core before and after heating according the present disclosure; and

FIG. 6 shows a simplified schematic illustration of a method for producing a stator for an electric machine according the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The detailed description below in conjunction with the appended drawings, in which identical numerals refer to identical elements, is intended as a description of various forms of the subject matter disclosed, and is not intended to represent the individual forms. Each variation described in this disclosure is used merely as an example or illustration and should not be interpreted as preferred or advantageous relative to other variations. The illustrative examples contained herein do not make any claim to completeness and do not limit the subject matter claimed to the precise forms disclosed. Various modifications of the forms described are readily discernible by a person skilled in the art, and the general principles defined herein can be applied to other forms and applications without departing from the spirit and scope of the forms described. Therefore, the forms described are not limited to the forms shown but have the greatest possible area of application that is compatible with the principles and features disclosed herein.

The features disclosed with reference to the exemplary forms and/or the accompanying figures can be combined singly or in any desired subcombination with features of the aspects of the disclosure, including features of variations, provided that the feature combination obtained makes sense for a person skilled in the art in this area of technology.

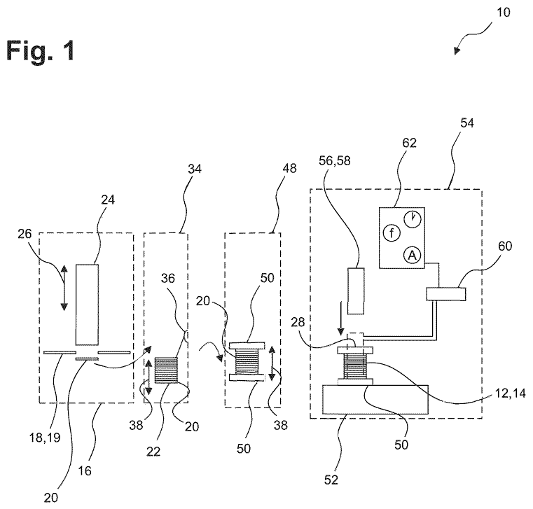

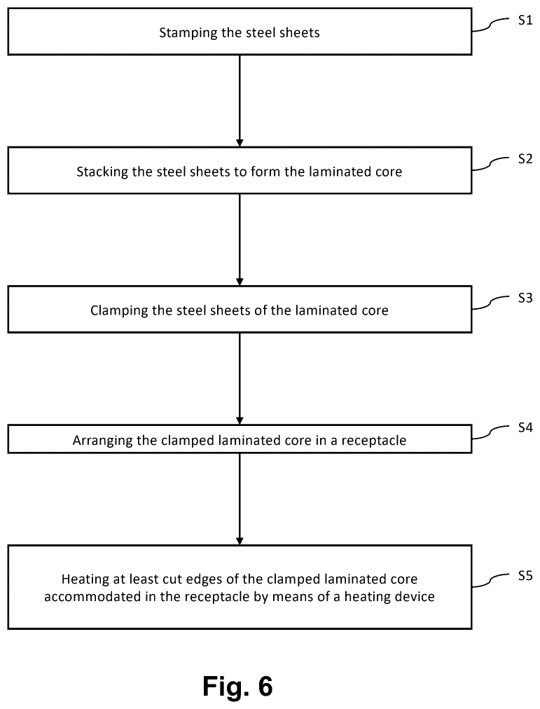

FIG. 1 shows a simplified schematic illustration of a system 10 for producing a stator 12 for an electric machine 14 according to one form. In this context, FIG. 6 discloses a simplified schematic illustration of a method 70 for producing a stator 12 for an electric machine 14 according to one form.

The system 10 has at least one stamping device 16. The stamping device 16 is supplied with a raw material 18, e.g. a steel sheet, typically by a conveying device. According to this form, the raw material 18 comprises electric sheet steel, but, alternatively, may also comprise a different material, in particular a soft magnetic material. According to this form, the raw material 18 already has an electric insulating coating comprising an electric insulating material 19.

According to step S1 of the method 70, the stamping device 16 is used to stamp steel sheets 20 of a laminated core 22 of the stator 12 out of the raw material 18. For this purpose, according to this form, the stamping device 16 uses a punch 24 which is aligned perpendicularly to the raw material 18 along the movement direction 26. The punch stamps the steel sheets 20 out of the raw material 18 according to the specified shape.

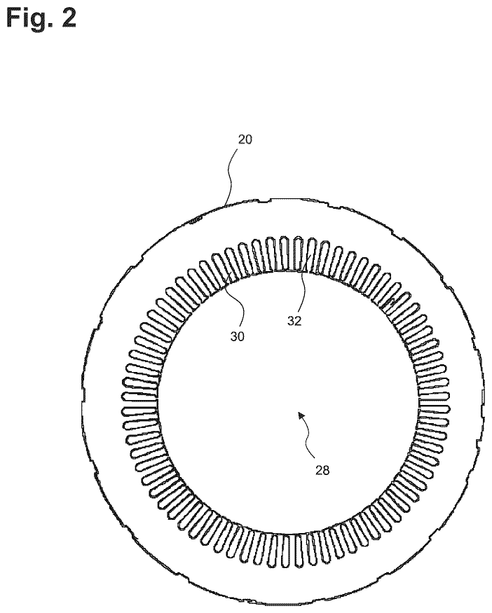

In this context, FIG. 2 shows a simplified schematic illustration of a stamped steel sheet 20 of a stator 12. The steel sheet 20 has a radially inner free space 28, in which the corresponding rotor is arranged after the assembly of the stator 12. In addition, the steel sheet 20 has a contour such that stator teeth 30 with tooth gaps 32 in between are formed. The stator teeth 30 and the tooth gaps 32 define a slot contour of the stator 12 in respect of the slotted portion which is formed by the stator teeth 30.

After the main body of the stator 12 has been produced from the laminated core 22, at least one winding is arranged in the tooth gaps 32 adjacent to the stator teeth 30. During the operation of the electric machine 14, the winding is energized, thus making it possible to generate a magnetic field to drive the rotor.

Following the stamping operation, the steel sheets 20 are fed to a stacking device 34 of the system 10. According to this form, the stacking device 34 has a movable gripping arm 36. For example, the gripping arm 36 may be configured to grip the steel sheets 20 by a suction device and then to position and align them as desired. The stacking device 34 of the system 10 is used to stack the steel sheets 20 along the axial direction 38 of the stator 12 to form the laminated core 22 in accordance with step S2 of the method 70. This means that adjacent steel sheets 20 are arranged adjacent to and adjoining one another in a direction which is oriented perpendicular to their substantially two-dimensional extent.

In respect of the alignment of the steel sheets 20 with respect to one another, the steel sheets can have markings, e.g. in the region of the radial outer circumference, which enable correct alignment of the steel sheets 20.

In one alternative, the stacking device 34 can also be designed as part of the stamping device 16. In this case, stacking and alignment of the steel sheets 20 takes place along the axial direction 38 of the stator 12 to form the laminated core 22 while still within the stamping device 16. In this form, the gripping arm 36 can of course be omitted. Step S2 of the method 70 is then designed as part of step S1 of the method 70 and is likewise performed by the stamping device 16.

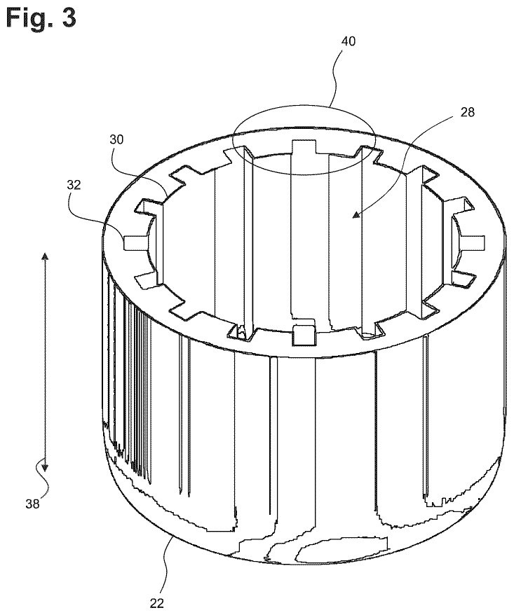

In this way, a laminated core 22 is formed from steel sheets 20, this laminated core also being illustrated by way of example in the simplified schematic illustration of the laminated core 22 of the stator 12 in FIG. 3. In this case, the steel sheets 20 have mutually corresponding shapes, and therefore uniform stator teeth 30 and tooth gaps 32 are formed.

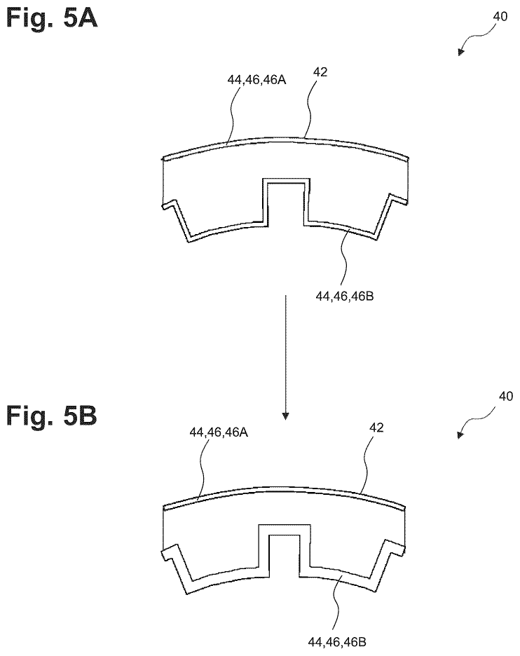

However, the stamping process by the stamping device 16 gives rise to structural ridges, e.g. in the form of cut edges. By way of example, a portion 40 of the laminated core 22 is shown in an enlarged view in the simplified schematic illustration in FIG. 5A.

The laminated core 22 has an external surface 42. Starting from the external surface 42, the laminated core 22 has structural ridges 44 within the external portion 46A. By way of example, the external portion can extend up to 1 mm, but typically up to about 0.5 mm, into the interior of the body of the laminated core 22. The structural ridges 44 are caused, for example, by cut edges brought about by the stamping process.

Even if, of course, the laminated core 22 has an external surface 42 situated radially on the outside, external portions 46B situated radially on the inside are naturally likewise affected by the effects caused by the stamping processes and likewise have structural ridges 44. Since the rotor is arranged adjacent to the external portions 46B situated radially on the inside, the structural ridges 44 of the external portions 46B situated radially on the inside have a greater effect on the operating efficiency of the electric machine 14. In particular, the structural ridges 44 in these regions make the effective formation of magnetic domains more difficult, as a result of which the coupling efficiency between the stator 12 and the rotor is negatively affected. In other words, more electric power is needed to enable the rotor to produce the same torque in relation to an external component. Of course, this has the effect that the energy consumption of the electric machine 14 is reduced relative to a configuration without the corresponding structural ridges 44. If the electric machine 14 is used for propulsion in a motor vehicle, for example, the range of the motor vehicle can be reduced by the cut edges, which represent illustrative structural ridges 44.

In order to counteract the structural ridges 44, the system 10 has at least one clamping device 48, which, according to step S3 of the method 70, is used to clamp the stacked stamped steel sheets 20 of the laminated core 22 at least along the axial direction 38 of the stator 12. For this purpose, the laminated core 22 is clamped between end clamps 50 of the clamping device 48, for example. In this way, it is possible to provide that the steel sheets 20 of the laminated core 22 cannot move relative to one another in the subsequent steps of the method 70 but maintain their relative position. For example, it is possible in this way to inhibit induced magnetic fields leading to adjacent steel sheets 20 being configured to move relative to one another on account of repelling forces that are caused.

Moreover, the system 10 comprises a receptacle 52, which is configured to accommodate the clamped laminated core 22 in accordance with step S4 of the method 70. This means that the clamped laminated core 22 is arranged on the receptacle 52 in step S4 of the method 70. As an option, this can also be accomplished in a mechanized and/or automated manner, e.g. by a gripping arm.

According to this form, the receptacle 52 is part of at least one heating device 54 of the system 10. According to step S5 of the method 70, the heating device 54 of the system 10 is used to heat at least cut edges of the clamped laminated core 22 accommodated in the receptacle 52 in such a way that eddy currents are induced in an external portion 46 of the laminated core 22. The external portion 46 does not necessarily refer to a radially outer region of the laminated core 22, but may likewise refer to a radially inner region of the laminated core 22, e.g. in the region of the stator slots.

In order to heat the laminated core 22, the heating device 54 according to this form has at least one inductor 56 which, at least in some portion or portions, comprises an inductor contour 58 corresponding in design to a contour of the laminated core 22, in particular to a slot contour of the slotted portion of the stator 12.

According to this form, the inductor is arranged at least partially in the free space 28 of the laminated core 22. In addition, the heating device 54 according to this form has a controllable power source 60 and a control device 62. The control device 62 is configured to control the controllable power source 60. As a consequence, the inductor 56 can be supplied with an alternating current, thereby making it possible to induce eddy currents in the steel sheets 20 of the laminated core 22. Here, the control device 62 controls the controllable power source 60 in such a way that the alternating current used has a high frequency, between at least 100 kHz and 2 MHz. In addition, the controllable power source 60 according to this form is controlled in such a way that a temperature of about 700° C. is maintained for about 1 s in the external portions 46 of the laminated core 22. By virtue of the high frequencies and as a consequence of the heating process, tensile stresses arise after the cooling of the laminated core 22, and these further reduce the iron losses in the underlying soft magnetic material, entailing additional advantages for the method 70.

Since the cut edges and illustrative structural ridges 44 form the basis of degradations in the steel sheets 20 of the laminated core 22, the electrical resistances are particularly high in the region of the cut edges. On the basis of Ohm's law, this has the effect that the cut edges, or general structural ridges 44, are heated to a disproportionately great extent by the induced eddy currents. In other words, the external portions 46, which have such structural ridges 44, are heated in particular. In contrast, the central region of the steel sheets 20 of the laminated core 22, which is situated further toward the inside, is not heated or is heated significantly less. This has the effect that the electric insulating material 19 of an insulating coating and/or adhesive coatings, which are typically already arranged on the raw material 18, are not negatively affected by the heating process. As a consequence, the electric insulation between the steel sheets 20 is preserved, and optional adhesive layers can furthermore be used for the permanent coupling of adjacent steel sheets 20.

For example, the actual mechanical coupling of adjacent steel sheets 20 in the context of the clamping of the laminated core 22 using the clamping device 48 can be accomplished by the adhesive layers. In one alternative, the mechanical coupling can also take place downstream of the method 70. In another alternative, the coupling of adjacent steel sheets 20 can take place already in the context of the production of the steel sheets 20, during the formation of the laminated cores 22.

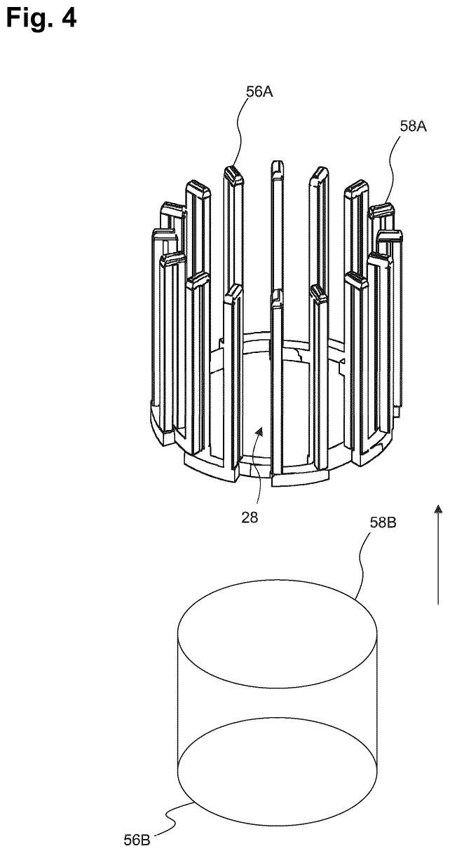

With regard to the heating process, which is made possible using the heating device 54, FIG. 4 shows a simplified schematic illustration of inductors 56A, 56B of the heating device 54.

The first inductor 56A has a specific inductor contour 58A, such that this is designed to correspond to the tooth gaps 32. Therefore, the first inductor 56A can be inserted at least partially into the tooth gaps 32.

In order to efficiently heat the ends of the stator teeth 30 as well, the heating device according to this form additionally has a second inductor 56B, which comprises a diverging inductor contour 58B. Here, the inductors 56 are such that the second inductor 56B can be inserted into the free space 28 of the first inductor 56A. As a result, the second inductor 56B is then arranged opposite the end faces of the stator teeth 30. As a consequence, it is possible, in particular, to heat the radially inner external portions 46B of the steel sheets 20 of the laminated core 22 using the heating device 54.

According to this form, the inductors 56 can be produced by an additive production method or by a soldering method, e.g. from semifinished products, in particular copper sheets and/or copper tubes.

The inductors 56 have internal cooling channels, through which a coolant flows. In this way, constant operating parameters of the inductors 56 during the heating process can be provided.

FIG. 5B shows a simplified schematic illustration of the portion 40 of the laminated core 22 after the heating process. Since the inductors 56 are designed and arranged in such a way that they are arranged opposite the radially inner external portions 46B during the heating process, the radially inner external portions 46B are heated in particular. This has the effect that the structural ridges 44 in these regions can be healed. In contrast, heat treatment of the radially outer external portions 46A may be omitted since these external portions 46A (external portions denoted generally by 46) assume only a subordinate role in respect of the interaction with the rotor.

Thus, the system 10 and the method 70 succeed in enabling the production of a stator 12 which has fewer structural ridges 44 in comparison with previous approaches, wherein the structural ridges 44 can be healed more efficiently than hitherto using an induction heating process. As a consequence, the operating efficiency of the stator 12 is increased in comparison with previous stators, and less waste is caused.

Following the heating process using the heating device 54, the laminated core 22 of the stator 12 can be fed to a subsequent processing station. For example, an electric insulating paper can be inserted into the tooth gaps 32 before ultimately the winding is formed.

A corresponding heating process for the rotor of the electric machine 14 can be omitted since the stator in any case contributes to higher core losses during an operating situation of the electric machine. Since the magnetic flux in the rotor of a permanent magnet synchronous machine (PMSM) changes only slightly, it is in any case not worthwhile to anneal the rotor.

In this disclosure, reference may be made to quantities and numbers. Unless explicitly stated, such quantities and numbers should not be regarded as restrictive but as examples of the possible quantities or numbers in connection with the disclosure. In this context, the term “plurality” may also be used in the disclosure to refer to a quantity or number. In this context, the term “plurality” refers to any number which is greater than one, e.g. two, three, four, five etc. The terms “about”, “approximately”, “close to” etc. mean plus or minus 5% of the indicated value.

Although disclosure has been explained and described with reference to one or more forms, a person skilled in the art will be able to make equivalent changes and modifications after reading and understanding this description and the appended drawings.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for producing a stator for an electric machine, the stator having a laminated core which has individual adjacently arranged steel sheets along an axial direction of the stator, at least some portion of the steel sheets having an electric insulating material, the method comprising:
stamping the steel sheets of a laminated core of a stator out of a raw material;
stacking the steel sheets along the axial direction of the stator to form the laminated core;
clamping the steel sheets of the laminated core at least along the axial direction of the stator;
arranging the clamped laminated core in a receptacle; and
heating at least cut edges of the clamped laminated core accommodated in the receptacle by a heating device in such a way that eddy currents are induced in at least one external portion of the laminated core.

2. The method according to claim 1, wherein the heating device heats the laminated core by an inductive heating method based on a high-frequency alternating current.

3. The method according to claim 1, wherein the external portion of the laminated core is heated for at least 0.1 second and a maximum heating time of 100 seconds.

4. The method according to claim 3, wherein the external portion of the laminated core has a maximum temperature of 1500°C. for the heating time.

5. The method according to claim 3, wherein the external portion of the laminated core is at a maximum distance of less than 10 mm from an external surface of the laminated core.

6. The method according to claim 1, wherein the cut edges of the clamped laminated core accommodated in the receptacle are heated by means of the heating device in such a way that tensile stresses are induced in the cut edges.

7. The method according to claim 1, wherein a material of the steel sheets is electric sheet steel.

8. The method according to claim 1, wherein at least one inductor is used for heating, the at least one inductor having an inductor contour corresponding to a contour of the laminated core.

9. A system for producing a stator for an electric machine comprising:
at least one stamping device configured to stamp steel sheets of a laminated core of a stator out of a raw material,
at least one stacking device configured to stack the stamped steel sheets along an axial direction of the stator to form a laminated core,
at least one clamping device configured to clamp the stacked stamped steel sheets of the laminated core at least along the axial direction of the stator,
a receptacle configured to accommodate the clamped laminated core, and
at least one heating device configured at least to heat at least cut edges of the clamped laminated core accommodated in the receptacle in such a way that eddy currents are induced in edge regions of the laminated core.

10. The system according to claim 9, wherein the heating device is configured to heat the cut edges of the laminated core by an alternating current, wherein the alternating current has a minimum frequency of at least 1 kHz and a maximum frequency of less than 20 MHz.

11. The system according to claim 9, wherein the heating device is configured to heat the cut edges of the clamped laminated core accommodated in the receptacle in such a way that tensile stresses are induced in the cut edges.

12. The system according to claim 9, wherein the heating device has at least one inductor, which is designed as a coil.

13. The system according to claim 12, wherein the inductor has at least one body portion which can be produced by an additive method and/or of a soldering method.

14. The system according to claim 13, wherein the body portion of the inductor has an inductor contour that corresponds in design to a slot contour of a slotted portion of the stator.

15. The system according to claim 12, wherein the inductor has at least one internal cooling channel, through which a coolant can flow.

16. The system according to claim 12, wherein the heating device has at least one additional inductor, wherein the additional inductor has an additional inductor contour in some portion or portions, which is designed to correspond to a cavity contour of an internal free space of the stator.
